(19) United States
(12) Patent Application Publication
(10) Pub. No.: US 2021/0174691 A1
(43) Pub. Date: Jun. 10, 2021

(54) COGNITIVE COACHING BASED ON CONTENT AND SENTIMENT ANALYSIS

(71) Applicant: International Business Machines Corporation, Armonk, NY (US)

(72) Inventors: Robert D. Dill, Raleigh, NC (US); David Jaramillo, Durham, NC (US); Bharatkumar Lakhiyani, Morrisvile, NC (US)

(21) Appl. No.: 16/704,390

(22) Filed: Dec. 5, 2019

(51) Int. Cl. G09B 5/06; G09B 5/14; G09B 19/00

(52) U.S. Cl. CPC G09B 5/065; G09B 19/00; G09B 5/14

(57) ABSTRACT

An approach to improve the quality of a presentation. An audio or a video recording of a presentation, presented with a selected topic, is translated to a textual transcript for processing. The textual transcript is divided into sections, comprising an opening, a body and a closing, associated with a story arc. The sections are analyzed based on a rubric prepared by an expert on the provided topic. Section scores and recommendations, based on the analysis, are provided to the presenter and optionally, the presenter can send the presentation to a reviewer for approval.

### TECHNICAL FIELD

The present invention relates generally to topic analysis and training, and more specifically, to cognitive coaching based on topic content and sentiment analysis.

### BACKGROUND

Typically, a company will have a large variety of products and services for sale to consumers. This large volume of products and services results in many individuals, associated with selling the products and services, requiring training on a specific product or service in order to prepare a customer specific sales presentation. In some cases, known as “elevator” or “stand and deliver” pitches, a salesperson must prepare a short description of a product, service, idea, or the company explaining the concept in a way such that any listener can understand it in a short period of time.

Finding an individual having both the time and expertise to review a prepared presentation, e.g., “elevator pitch,” for content correctness and appeal can be difficult. Further, scheduling a presentation review with the newly discovered expert, that meets a customer presentation timing requirement, can be problematic and can lead to presentations to customers that are less than optimal. For example, after seeing a misguided presentation, a customer may decide the company's offerings do not meet their needs or develop expectations that are not in line with the company's offerings.

### BRIEF SUMMARY

According to an embodiment of the present invention, a computer-implemented method for improving the quality of a presentation, the computer-implemented method comprising: receiving, by one or more processors, a recording of a presentation and a topic of the presentation from a presenter, wherein the recording is an audio recording, a video recording or a text transcript; responsive to the recording being an audio recording, translating, by the one or more processors, the recording into a text transcript of the presentation; dividing, by the one or more processors, the text transcript into a plurality of sections; analyzing, by the one or more processors, the plurality of sections based on a rubric associated with the topic; generating, by the one or more processors, section scores and section improvement recommendations for the plurality of sections; and presenting, by the one or more processors, the section scores and section improvement recommendations to the presenter.

According to an embodiment of the present invention, a computer program product for improving the quality of a presentation, the computer program product comprising: one or more non-transitory computer readable storage media and program instructions stored on the one or more non-transitory computer readable storage media, the program instructions comprising: program instructions to receive a recording of a presentation and a topic of the presentation from a presenter, wherein the recording is an audio recording, a video recording or a text transcript; responsive to the recording being an audio recording, program instructions to translate the recording into a text transcript of the presentation; program instructions to divide the text transcript into a plurality of sections; program instructions to analyze the plurality of sections based on a rubric associated with the topic; program instructions to generate section scores and section improvement recommendations for the plurality of sections; and program instructions to present the section scores and section improvement recommendations to the presenter.

According to an embodiment of the present invention, a computer system for improving the quality of a presentation, the computer system comprising: one or more computer processors; one or more computer readable storage media; and program instructions stored on the one or more computer readable storage media for execution by at least one of the one or more processors, the program instructions comprising: program instructions to receive a recording of a presentation and a topic of the presentation from a presenter, wherein the recording is an audio recording, a video recording or a text transcript; responsive to the recording being an audio recording, program instructions to translate the recording into a text transcript of the presentation; program instructions to divide the text transcript into a plurality of sections; program instructions to analyze the plurality of sections based on a rubric associated with the topic; program instructions to generate section scores and section improvement recommendations for the plurality of sections; and program instructions to present the section scores and section improvement recommendations to the presenter.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment, according to embodiments of the present invention.

FIG. 2 depicts abstraction model layers, according to embodiments of the present invention.

FIG. 3 is a high-level architecture, according to embodiments of the present invention.

FIG. 4 is an exemplary detailed architecture, according to embodiments of the present invention.

FIG. 5 is a flowchart of a method, according to embodiments of the present invention.

FIG. 6 is a block diagram of internal and external components of a data processing system in which embodiments described herein may be implemented, according to embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of cognitive coaching based on topic content and sentiment analysis. It should be noted that the term software, as used herein, includes any type of computer instructions such as, but not limited to, firmware, microcode, etc.

In one general embodiment, a computer-implemented method includes receiving a presentation from a user; identifying a topic of the presentation based on analyzing the presentation; and parsing the presentation into a plurality of sections. The computer-implemented method also includes generating a plurality of key phrases, respective to the plurality of sections; generating a plurality of characteristics, respective to the plurality of key phrases, based on natural language understanding; and generating a plurality of coaching points, respective to the plurality of characteristics, based on a predetermine rubric associated with the topic. Then the computer-implemented method operates by presenting the plurality of coaching points, respective to the plurality of sections, to the user.

In another general embodiment, a system includes a processor and logic integrated with the processor, executable by the processor, or integrated with and executable by the processor. The logic is configured to perform the foregoing computer-implemented method.

In another general embodiment, a computer program product for install-time software validation includes a computer-readable storage medium having program instructions embodied therewith. The program instructions are executable by a computer to cause the computer to perform the foregoing computer-implemented method.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

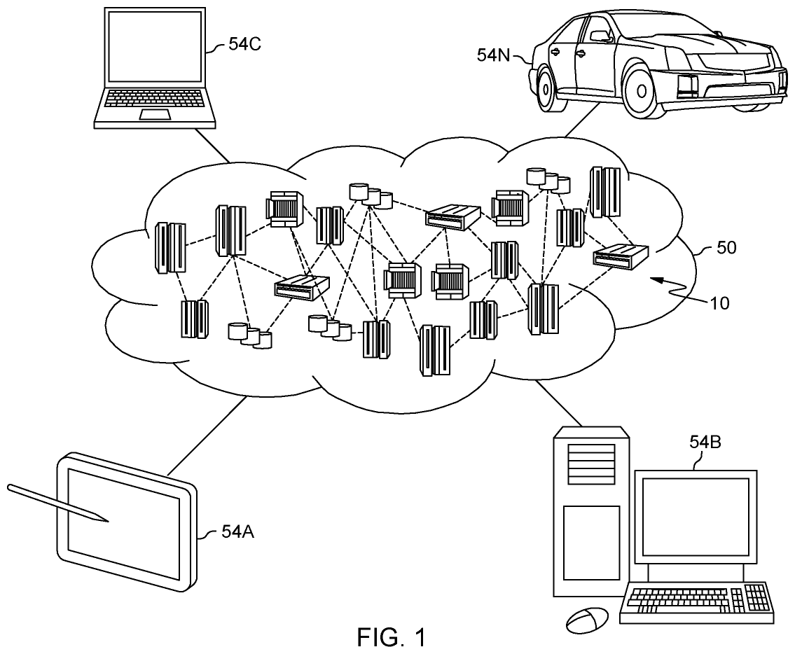

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

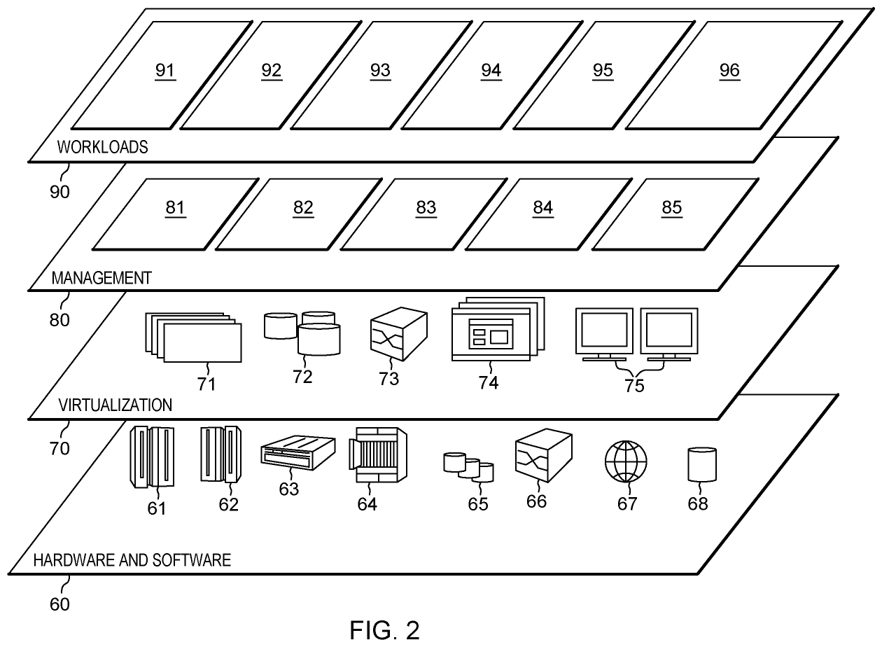

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and cognitive coaching based on topic content and sentiment analysis 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

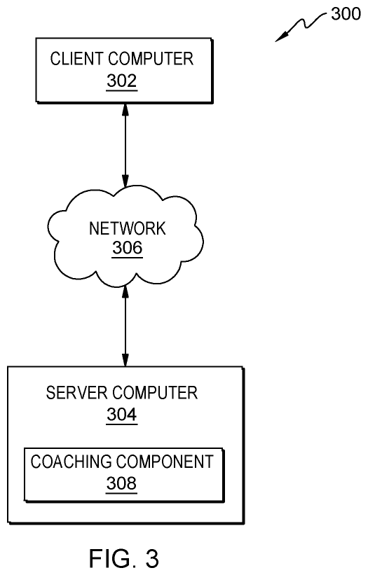

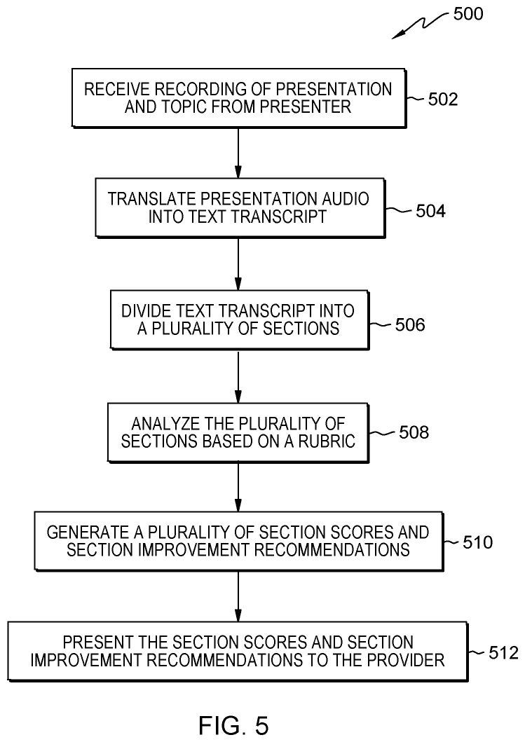

FIG. 3 is a high-level architecture for performing various operations of FIG. 5, in accordance with various embodiments. The architecture 300 may be implemented in accordance with the present invention in any of the environments depicted in FIGS. 1-4, among others, in various embodiments. Of course, more or less elements than those specifically described in FIG. 3 may be included in architecture 300, as would be understood by one of ordinary skill in the art upon reading the present descriptions.

Each of the steps of the method 500 (described in further detail below) may be performed by any suitable component of the architecture 300. A processor, e.g., processing circuit(s), chip(s), and/or module(s) implemented in hardware and/or software, and preferably having at least one hardware component may be utilized in any device to perform one or more steps of the method 500 in the architecture 300. Illustrative processors include, but are not limited to, a central processing unit (CPU), an application specific integrated circuit (ASIC), a field programmable gate array (FPGA), etc., combinations thereof, or any other suitable computing device known in the art.

Architecture 300 includes a block diagram showing an exemplary processing system for a cognitive coaching based on topic content and sentiment analysis environment to which the invention principles may be applied. The architecture 300 comprises a client computer 302, a coaching component 308 operational on a server computer 304 and a network 306 supporting communication between the client computer 302 and the server computer 304.

Client computer 302 can be any computing device on which software is installed for which an update is desired or required. Client computer 302 can be a standalone computing device, management server, a web server, a mobile computing device, or any other electronic device or computing system capable of receiving, sending, and processing data. In other embodiments, client computer 302 can represent a server computing system utilizing multiple computers as a server system. In another embodiment, client computer 302 can be a laptop computer, a tablet computer, a netbook computer, a personal computer, a desktop computer or any programmable electronic device capable of communicating with other computing devices (not shown) within user persona generation environment via network 306.

In another embodiment, client computer 302 represents a computing system utilizing clustered computers and components (e.g., database server computers, application server computers, etc.) that act as a single pool of seamless resources when accessed within install-time validation environment of architecture 300. Client computer 302 can include internal and external hardware components, as depicted and described in further detail with respect to FIG. 5.

Server computer 304 can be a standalone computing device, management server, a web server, a mobile computing device, or any other electronic device or computing system capable of receiving, sending, and processing data. In other embodiments, server computer 304 can represent a server computing system utilizing multiple computers as a server system. In another embodiment, server computer 304 can be a laptop computer, a tablet computer, a netbook computer, a personal computer, a desktop computer, or any programmable electronic device capable of communicating with other computing devices (not shown) within install-time validation environment of architecture 300 via network 306.

Network 306 can be, for example, a local area network (LAN), a wide area network (WAN) such as the Internet, or a combination of the two, and can include wired, wireless, or fiber optic connections. In general, network 306 can be any combination of connections and protocols that will support communications between client computer 302 and server computer 304.

Coaching component 308 interacts with the user or system preparing or presenting a presentation, e.g., elevator presentation, stand-and-deliver pitch, etc., on client computer 302 to determine if the presentation meets the minimum quality requirements of an organization. Coaching component 308 can evaluate a presentation based on a story arc comprising an opening, body and closing and provides coaching based on a combination of content analysis, sentiment analysis of the presenter and story stage analysis. It should be noted that coaching component 308 can review a recorded presentation or a live presentation.

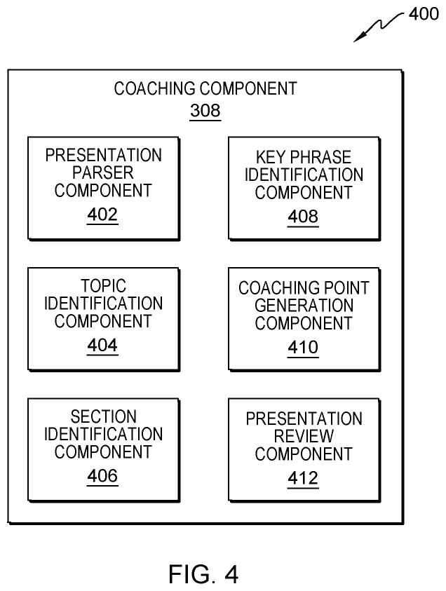

FIG. 4 is an exemplary detailed architecture for performing various operations of FIG. 5, in accordance with various embodiments. The architecture 400 may be implemented in accordance with the present invention in any of the environments depicted in FIGS. 1-3 and 5, among others, in various embodiments. Of course, more or less elements than those specifically described in FIG. 4 may be included in architecture 400, as would be understood by one of skill in the art upon reading the present descriptions.

Each of the steps of the method 500 (described in further detail below) may be performed by any suitable component of the architecture 400. A processor, e.g., processing circuit(s), chip(s), and/or module(s) implemented in hardware and/or software, and preferably having at least one hardware component, may be utilized in any device to perform one or more steps of the method 500 in the architecture 400. Illustrative processors include, but are not limited to, a central processing unit (CPU), an application specific integrated circuit (ASIC), a field programmable gate array (FPGA), etc., combinations thereof, or any other suitable computing device known in the art.

Architecture 400 provides a detailed view of at least some of the modules of architecture 300. Architecture 400 can comprise a coaching component 308, which can further comprise a presentation parser component 402, a topic identification component 404, a section identification component 406, a key phrase identification component 408, a coaching point generation component 410 and a presentation review component 412.

The presentation parser component 402 can provide video or streaming processing to listen to audio and/or video, provided by a user, based on Watson™ Speech to Text, Watson™ Natural Language Understanding, Watson™ Tone Analyzer, and/or Watson™ Natural Language Classifier. (International Business Machines Corporation (IBM), 1 New Orchard Road, Armonk, N.Y. 10504, United States). Any known technique may be used to perform natural language processing including Google Cloud® Natural Language, Natural Language Toolkit, Apache Lucene™, Apache Solr™, Apache OpenNLP™, CoreNLP™, SpaCy®, etc. In a preferred embodiment, the natural language processing is performed using Watson™ Natural Language Understanding, Watson™ Tone Analyzer, and/or Watson™ Natural Language Classifier. The aforementioned and additional Watson APIs may be used to perform various operations of the methods described in further detail below in FIGS. 4 and 5.

In a preferred embodiment, the audio associated with the presentation is converted to a text file transcript by Watson™ Speech to Text for further analysis. The generated transcript is subsequently used for both content and sentiment analysis. For example, sentiment analysis can be performed by Watson™ Tone Analyzer and Watson™ Sentiment Analyzer to look for emotional responses by the presenter to analyze comfort with the presentation and to analyze a precepted level of confidence with the presentation. In another example, content analysis can be performed by Watson™ Natural Language Understanding and Watson™ Natural Language Classifier to look for words and phrases which content experts would expect to find in a presentation on the presentation topic.

The presentation parser component 402 provides the capability for the user to confirm the translation of the presentation audio. The presentation parser component provides an interface to the user allowing the user to listen to the presentation audio while viewing an editable version of the generated transcript. The user can correct any errors in transcript generation, add additional content or remove any unwanted content from the transcript before submitting the transcript for further analysis. After completing the review, the user can save both the originally generated transcript and the adapted version of the transcript.

The topic identification component 404 comprises a predefined list of topics configured for coaching. The topics are defined and described by subject matter experts associated with the topics. The topic identification component 404 receives input from the user selecting a topic from the predefined list of topics. The selected topic configuration comprises targeted content for the story arc of the topic based on an opening, a body and a closing.

The section identification component 406 can divide the content of the presentation into sections comprising an opening, a body and a closing. For example, a story arc has an opening, i.e., introduction, wherein the purpose of the introduction is to grab the attention of an observer with a sparkler. It should be noted that the term “sparkler” is often used to describe a one-sentence reference or highlight associated with the topic. Following the opening, the body of the story arc proceeds with a period of rising action for approximately two-thirds of the body, the remaining one-third of the body of the story arc comprises a falling action. The closing of the story arc then completes the presentation.

Further, section identification component 406 can analyze “how” a word or phrase is pronounced. For example, using audio, the tone of how a phrase was spoken can be evaluated to determine the level of the presenter's enthusiasm for the topic of the presentation. In another example, using video, the facial expressions of the presenter can be evaluated in like fashion to determine the level of comfort the presenter has in delivering the topic of the presentation.

The key phrase identification component 408 can parse the sections created by the section identification component 406 and detect expected or missing phrases associated with a presentation of the selected topic. For example, the key phrase identification component 408, based on the selected preconfigured topic, can look for sparklers in the opening of the story arc and note the presence or absence of sparklers. In another example, the key phrase identification component 408 can analyze the body content to look for words and phrases expected to be found in the selected topic. In another example, the key phrase identification component 408 can analyze the closing content and identify phrases, present or missing, indicating, for example, a request to schedule a follow-up meeting to discuss further details associated with the selected topic. It should be noted that the key phrase identification component 408 can look for a concrete request for a meeting, i.e., parsing for a “when,” e.g., today, tomorrow, Tuesday, this week, next week, etc., and a specific “who” to attend a meeting, e.g., you, your team, your staff, Jim and Joan, etc. It should further be noted that other desired actions can be configured for identification in the opening, body or closing of a presentation.

In another aspect, the key phrase identification component 408 can perform a sentiment analysis of the content of the identified sections based on identified sentiment phrases. It should be noted that sentiment phrases are phrases indicating the comfort level of the presenter and the confidence tone detected in the information conveyed concerning the topic. For example, the sentiment analysis focuses on the tone of phrases expressing the key concepts of the selected topic and the voice comfort with which the content is delivered.

Coaching point generation component 410 can provide feedback on how the presenter performed in each of the four primary areas, i.e., the opening, the body, the rising and the closing and how the presenter can improve these areas. For example, with respect to a sentiment analysis of the opening, coaching point generation component 410 can provide feedback comprising a numerical score for the opening, e.g., 79, and a description of deficiencies and suggested improvements, e.g., “your opening lacks your natural confidence.” In another example, with respect to content analysis of the closing, coaching point generation component 410 can provide feedback comprising a numerical score for the closing, e.g., 46, and a description of deficiencies and suggested improvements, e.g., “your close is missing a concrete request to meet on a specific day.” Coaching point generation component 410 can provide similar feedback for each area, an overall score for the presentation and a recommended target score. It should be noted that the target score can be based on historical scores for the organization or on a predetermined score selected by the associated content expert.

Coaching point generation component 410 generates scores and feedback based on a rubric, e.g., an assessment model, uniquely defined for each topic by the topic expert. The rubric can provide for score valuations based on individual areas and on an overall basis with adjustments based on a provided intended audience for the presentation. It should be noted that the rubric can be dynamically and/or automatically updated based on training with historically archived presentations and their associated rubrics. The rubric can comprise key phrases expected to appear in the presentation based on the topic selection.

The presentation review component 412 provides the capability for a reviewer to review a presentation after the presentation is incorporated with the suggested improvements. It should be noted that a presentation can be iterated through the coaching point generation component 410 as many times as the presenter desires to improve the presentation and the associated scores before submitting the presentation for review.

The presentation review component 412 can provide a presenter an interface to select a reviewer. A reviewer can be, for example, the presenter's manager, an automatically selected reviewer from a pool of reviewers or a reviewer of the presenter's choice from a predefined list. It should be noted that the pool of reviewers and the predefined list of reviewers are based on the selected topic of the presentation. The presentation review component 412 presents the reviewer with the presentation analysis, the coaching results, the section scoring results and the overall scoring result generated by the coaching point generation component 410. The reviewer can return the presentation, with comments, to the presenter for more refinement or can approve the presentation, optionally with comments. It should be noted that approved presentations can be stored for future analysis and use in tuning rubrics for other presentations.

FIG. 5 is an exemplary flowchart of a method 500 for improving the quality of a presentation. Looking to step 502, an embodiment can receive a presentation recording from a presenter via coaching component 308. The presenter can also make a selection of a topic of the presentation from a predefined list of topics via topic identification component 404. It should be noted that a user interface (not shown) can provide the presenter a mechanism to select the topic from the predefined list and send the presentation recording to coaching component 308.

Turning to step 504, the presentation recording audio can be converted to a text transcript for processing by functionality associated with the various Watson™ interfaces via presentation parser component 402. Looking now to step 506, the text transcript can be divided into a plurality of sections associated with a story arc, e.g., an opening, a body and a closing via section identification component 406.

Considering step 508, the plurality of sections can be analyzed for key phrases by the various Watson™ interfaces via key phrase identification component 408. The analysis can be based on a rubric associated with the selected topic. Looking to step 510, a plurality of section scores and section improvement recommendations can be generated via coaching point generation component 410. It should be noted that the rubric can provide examples of desired words and phrases expected to appear in the presentation based on the selected topic and the presentation can be checked for these expected words and phrases. It should also be noted that the selection of words analyzed in the presentation and the tone of the presenter in while speaking the audio portion of the presentation can be used to perform a sentiment analysis by functionality associated with the appropriate Watson™ interfaces to allow coaching based on the presenters sentiment.

Turning to step 512, the section scores and the section improvement recommendations can be provided to the presenter by a graphical user interface (not shown) for presenter review. It should be noted that, optionally, the presenter can send the presentation, the section scores and the section improvement recommendations to a reviewer, selected by the presenter via presentation review component 412, to approve the presentation for use.

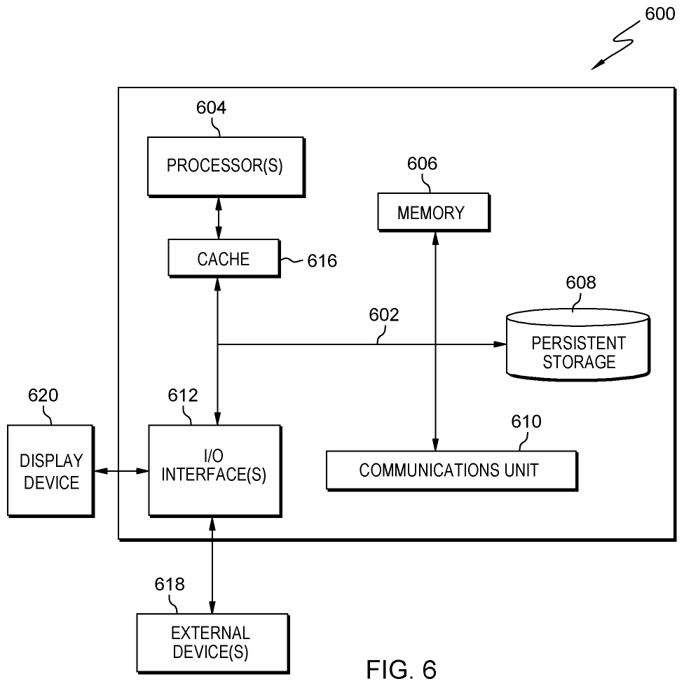

FIG. 6 depicts computer system 600, an example computer system representative of client computer 302 and server computer 304. Computer system 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Computer system 600 includes processors 604, cache 616, memory 606, persistent storage 608, communications unit 610, input/output (I/O) interface(s) 612 and communications fabric 602. Communications fabric 602 provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of processors 604 by holding recently accessed data, and data near recently accessed data, from memory 606.

Program instructions and data used to practice embodiments of the present invention may be stored in persistent storage 608 and in memory 606 for execution by one or more of the respective processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608. Communications unit 610, in these examples, provides for communications with other data processing systems or devices. In these examples, communications unit 610 includes one or more network interface cards. Communications unit 610 may provide communications through the use of either or both physical and wireless communications links. Program instructions and data used to practice embodiments of the present invention may be downloaded to persistent storage 608 through communications unit 610.

I/O interface(s) 612 allows for input and output of data with other devices that may be connected to each computer system. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for improving the quality of a presentation, the computer-implemented method comprising:
receiving, by one or more processors, a recording of a presentation and a topic of the presentation from a presenter, wherein the recording is an audio recording, a video recording or a text transcript;
responsive to the recording being an audio recording, translating, by the one or more processors, the recording into a text transcript of the presentation;
dividing, by the one or more processors, the text transcript into a plurality of sections;
analyzing, by the one or more processors, the plurality of sections based on a rubric associated with the topic;
generating, by the one or more processors, section scores and section improvement recommendations for the plurality of sections; and
presenting, by the one or more processors, the section scores and section improvement recommendations to the presenter.

2. The computer-implemented method of claim 1, wherein the audio recording is an audio stream of a video recording.

3. The computer-implemented method of claim 1, wherein the sections are an opening, a body and a closing, and wherein the body further comprises a rising action.

4. The computer-implemented method of claim 1, wherein the analyzing comprises a content analysis and a sentiment analysis.

5. The computer-implemented method of claim 4, wherein the content analysis further comprises identifying key phrases in the presentation based on the rubric and the sentiment analysis further comprises identifying facial expressions in the presentation based on the rubric.

6. The computer-implemented method of claim 1, wherein the rubric is prepared by a topic content expert associated with the topic

7. The computer-implemented method of claim 1, further comprising:
presenting, by the one or more processors, a plurality of presentation reviewer choices to the presenter for selection;
receiving, by the one or more processors, a presenter selection of a presentation reviewer choice;
sending, by the one or more processors, the presentation to the presenter selection for review; and
receiving, by the one or more processors, review results from the reviewer, wherein the review results approve the presentation or require further refinement of the presentation.

8. A computer program product for improving the quality of a presentation, the computer program product comprising:
one or more non-transitory computer readable storage media and program instructions stored on the one or more non-transitory computer readable storage media, the program instructions comprising:
program instructions to receive a recording of a presentation and a topic of the presentation from a presenter, wherein the recording is an audio recording, a video recording or a text transcript;
responsive to the recording being an audio recording, program instructions to translate the recording into the text transcript of the presentation;
program instructions to divide the text transcript into a plurality of sections;
program instructions to analyze the plurality of sections based on a rubric associated with the topic;
program instructions to generate section scores and section improvement recommendations for the plurality of sections; and
program instructions to present the section scores and section improvement recommendations to the presenter.

9. The computer program product of claim 8, wherein the audio recording is an audio stream of a video recording.

10. The computer program product of claim 8, wherein the sections are an opening, a body and a closing, and wherein the body further comprises a rising action.

11. The computer program product of claim 8, wherein the analyzing comprises a content analysis and a sentiment analysis.

12. The computer program product of claim 11, wherein the content analysis further comprises identifying key phrases in the presentation based on the rubric and the sentiment analysis further comprises identifying facial expressions in the presentation based on the rubric.

13. The computer program product of claim 8, wherein the rubric is prepared by a topic content expert associated with the topic

14. The computer program product of claim 8, further comprising:
program instructions to present a plurality of presentation reviewer choices to the presenter for selection;
program instructions to receive a presenter selection of a presentation reviewer choice;
program instructions to send the presentation to the presenter selection for review; and
program instructions to receive review results from the reviewer, wherein the review results approve the presentation or require further refinement of the presentation.

15. A computer system for improving the quality of a presentation, the computer system comprising:
one or more computer processors;
one or more computer readable storage media; and
program instructions stored on the one or more computer readable storage media for execution by at least one of the one or more processors, the program instructions comprising:
program instructions to receive a recording of a presentation and a topic of the presentation from a presenter, wherein the recording is an audio recording, a video recording or a text transcript;
responsive to the recording being an audio recording, program instructions to translate the recording into the text transcript of the presentation;
program instructions to divide the text transcript into a plurality of sections;
program instructions to analyze the plurality of sections based on a rubric associated with the topic;
program instructions to generate section scores and section improvement recommendations for the plurality of sections; and
program instructions to present the section scores and section improvement recommendations to the presenter.

16. The computer system of claim 15, wherein the sections are an opening, a body and a closing, and wherein the body further comprises a rising action.

17. The computer system of claim 15, wherein the analyzing comprises a content analysis and a sentiment analysis.

18. The computer system of claim 17, wherein the content analysis further comprises identifying key phrases in the presentation based on the rubric and the sentiment analysis further comprises identifying facial expressions in the presentation based on the rubric.

19. The computer system of claim 15, wherein the rubric is prepared by a topic content expert associated with the topic.

20. The computer system of claim 15, further comprising:
program instructions to present a plurality of presentation reviewer choices to the presenter for selection;
program instructions to receive a presenter selection of a presentation reviewer choice;
program instructions to send the presentation to the presenter selection for review; and
program instructions to receive review results from the reviewer, wherein the review results approve the presentation or require further refinement of the presentation.
